(19) United States
(12) Patent Application Publication
(10) Pub. No.: US 2026/0139819 A1
(43) Pub. Date: May 21, 2026

(54) MOUNTING CLIP FOR A LIGHT SYSTEM

(71) Applicant: Amerigen LLC, St. Petersburg, FL (US)

(72) Inventor: Adam Kelly, Sand Lake, MI (US)

(73) Assignee: Amerigen LLC, St. Petersburg, FL (US)

(21) Appl. No.: 19/352,539

(22) Filed: Oct. 8, 2025

Related U.S. Application Data
(60) Provisional application No. 63/705,199, filed on Oct. 9, 2024.

(51) Int. Cl. F21V 21/088; F21S 4/10; F21W 121/00

(52) U.S. Cl. CPC F21V 21/088; F21S 4/10; F21W 2121/004

(57) ABSTRACT

A mounting clip mounts a set of conduit to a building. The mounting clip has aa receiving body and a first arm. The receiving body is adapted to receive the set of conduit. The first arm extends from the receiving body. The first arm includes a main body and a hooked end collectively forming a first lock for securing the mounting clip to the building.

### CROSS-REFERENCE TO RELATED APPLICATION(S)

This application claims priority to and the benefit of U.S. Provisional Application No. 63/705,199, filed Oct. 9, 2024, which is incorporated herein by reference in its entirety.

### TECHNICAL FIELD

The present invention relates generally to a mounting clip for a light system, and more specifically to a mounting clip configured to mount the light system to a fascia of a building.

### BACKGROUND

Light systems include a set of lights in the form of a light bulb, light strip, or the like. Decorative light systems can be mounted to a building in order to emit a light onto the building or within an area near to the building. The lighting system is mounted to the building in various ways. For example, in residential applications where the building is a house, the light systems can be mounted to an exterior wall, a fascia, or a roof of the house. The light systems are mounted to the house through conventional mounting methods such as using nails, hangers, clips, staples, adhesives, or the like. Some of these conventional mounting methods, such as the use of nails, hangers and staples can cause damage to the building itself when the conventional mounting method is coupled to the building. The conventional mounting methods can cause immediate damage to the building when coupling the conventional mounting method to the house, or otherwise be labor intensive to apply. Additionally, some conventional mounting methods (e.g., staples, nails, adhesives, etc.) may not be reversible without causing damage to the building.

### BRIEF DESCRIPTION OF THE DRAWINGS

A full and enabling disclosure, including the best mode thereof, directed to one of ordinary skill in the art, is set forth in the specification, which makes reference to the appended figures in which:

FIG. 1 is a schematic perspective view of a building and a light system mounted to the building through use of a set of mounting clips in accordance with various aspects described herein.

FIG. 2 is a cross-sectional side view of the building as seen from sectional line II-II of FIG. 1, further illustrating a receiving body, a first lock and a second lock of the set of mounting clips in accordance with various aspects described herein.

FIG. 3 is a schematic perspective view a mounting clip of the set of mounting clips of FIG. 1, further illustrating the receiving body, the first lock and the second lock of the set of mounting clips in accordance with various aspects described herein

### DETAILED DESCRIPTION

Aspects of the disclosure are related to a mounting clip used to mount a light system to a building. The mounting clip includes a receiving body, a first lock, and a second lock. The receiving body is adapted to accept a portion of the light system. The first lock and the second lock are adapted to removably couple the mounting clip to a respective portion of the building.

The mounting clip as described herein is removable from the building. As such, the mounting clip can be used multiple times or in different locations. Coupling the mounting clip to the building and removing the mounting clip from the building does not cause damage to the building itself.

The building can be, for example, a residential house. The light system can be, for example, a decorative light system. The mounting clip, and therefore the light system, is selectively couplable to the building through use of the mounting clip. As used herein, the phrase “selectively couplable”, “selectively couple”, or iterations thereof refers to the mounting of the light system to the building in a reversible fashion. Put another way, the mounting clip, and therefore the light system, can be coupled to and decoupled from the building; therefore, the mounting clip, and therefore the light system, is selectively couplable to the building.

While described in terms of a mounting clip used to mount a decorative light system to a residential house, it will be appreciated that the mounting clip can be used to mount any suitable light system to any suitable building. As a non-limiting example, the light system can be at least one of, but is not limited to, the decorative light system, a security light system, a utility light system, or a combination thereof. As a non-limiting example, the building can be, but is not limited to, the residential house, a commercial residential property, a commercial property, a warehouse, an office, a fence, a deck, a wall, or the like.

The term “fore” or “forward” means in front of something and “aft” or “rearward” means behind something. Furthermore, as used herein, the term “set” or a “set” of elements can be any number of elements, including only one.

Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

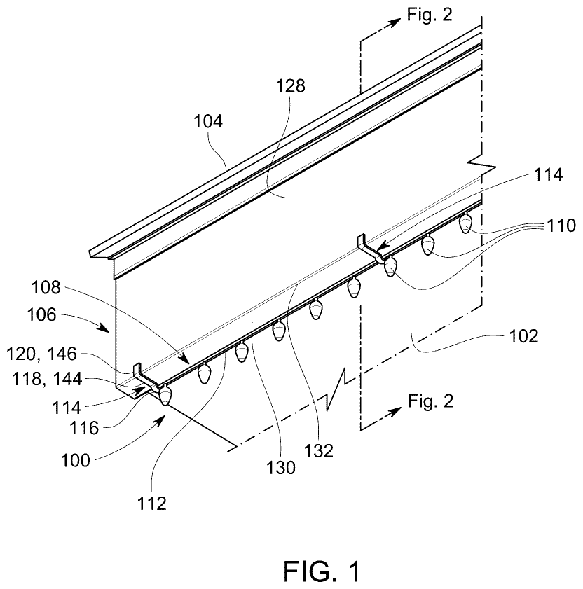

FIG. 1 is a schematic perspective view of a building 100. A light system 108 is mounted to the building 100. A set of mounting clips 114 selectively couple the light system 108 to the building 100. The building 100 is any suitable building 100 as described herein. As a non-limiting example, the building 100 is a residential house. The light system 108 is any suitable light system 108 as described herein. As a non-limiting example, the light system 108 is a decorative light system.

The building 100 includes an exterior wall 102 and a roof 104. The exterior wall 102 can be various types of wall exposed to the environment surrounding the building 100. As a non-limiting example, the exterior wall 102 can be at least one of a brick wall, a stone wall, a wooden wall, siding, metal sheets, a chimney, or a combination thereof. The building 100 can include a fascia 106. The fascia 106 includes a fascia surface 128 and a lip 130 extending from the fascia surface 128. The lip 130 and the fascia surface 128 meet at a transition edge 132. The fascia surface 128 is defined as an exposed surface of the fascia 106 that is exposed to and visible from the environment that the building 100 is located within. The lip 130 can be a continuation of the fascia surface 128 that extends transverse to or otherwise non-parallel to a remainder of the fascia surface 128. The fascia 106 can be various types of fascia. As a non-limiting example, the fascia 106 can be at least one of, a stone fascia, a wood fascia, a plastic fascia, a metallic fascia, or a combination thereof. The fascia 106 overlies at least a portion of the exterior wall 102.

The light system 108 includes a set of lights 110 and a set of lighting wires 112. The set of lights 110 can be various lights or combination of lights. As a non-limiting example, the set of lights 110 can include, but are not limited to, a light emitting diode (LED), A-shaped bulb, a covered compact fluorescent light (CFL) bulb, a globe bulb, a candle bulb, an indoor reflector bulb, an outdoor reflector bulb, an LED strip, track lighting, string lights, or the like. As illustrated, the set of lights 110 are bulb-type string lights. The set of lighting wires 112 can include sets of internal cables wrapped in layers of insulation. An outermost layer of the layers of insulation of the set of light wires 112 can be exposed to the environment. Alternatively, the set of lighting wires 112 can be housed within a conduit. For example, the set of lighting wires 112 can be housed within a plastic or metallic conduit to further protect the set of light wires 112 from the environment. The set of lighting wires 112 connects adjacent lights of the set of lights 110. The set of lighting wires 112 is configured to convey an electrical power from power source (not illustrated) and to the set of lights 110. The power source can be, for example, a battery, an engine, a generator, a main power source of the building 100, or the like.

Each mounting clip of the set of mounting clips 114 includes a receiving body 116 and a first arm 118. The receiving body 116 is defined as any portion of the mounting clip that is adapted to receive or otherwise accept a portion of the light system 108. Specifically, the receiving body 116 is adapted to receive or otherwise accept the set of light wires 112 The first arm 118 extends outward from the receiving body 116. The first arm 118 forms a hook at a distal end from the receiving body 116. As used herein, a “hook” is defined as a structure including a main body with a hooked end that is curved or otherwise bent back at an angle with respect to the main body. The first arm 118 includes a first main body 144 and a first hooked end 146. The first main body 144 and the first hooked end 146 collectively form a first lock 120. The first arm 118 is formed as an L-shaped hook, as illustrated) extending from the receiving body 116. Put another way, the first hooked end 146 extends from the first main body 144 in such a way to form the L-shaped hook. It will be appreciated, however, that the first arm 118 has any suitable hooked formation such as a J-shaped hook, the L-shaped hook, a U-shaped hook, or the like. The set of mounting clips 114 includes any number of one or more mounting clips.

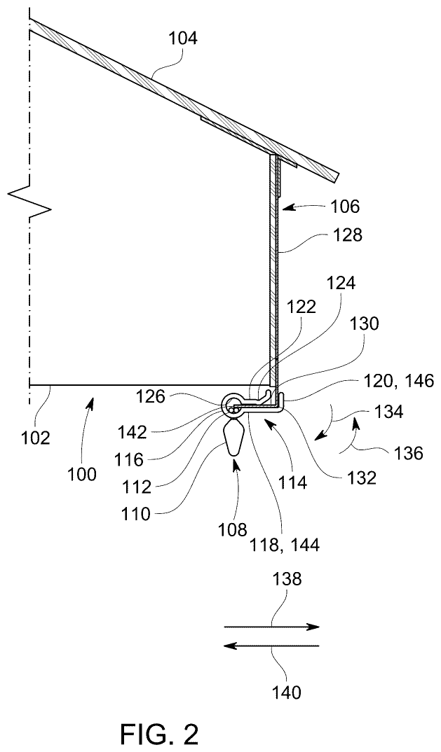

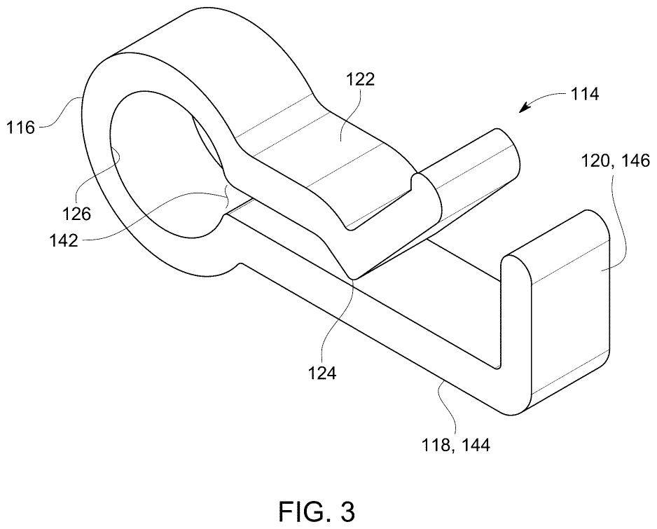

Each mounting clip of the set of mounting clips 114 is formed as a unitary body. The unitary body can include various materials. As a non-limiting example, the mounting clip unitary body material can include, but is not limited to, a metallic, or a polymer. In all cases, it will be appreciated that the material of the mounting clip is defined as an elastic material such that the mounting clip is urged to return to its original (e.g., manufactured) shape after being stretched or compressed. The original shape that each mounting clip of the set of mounting clips 114 returns to is illustrated in FIG. 3, which will be described in further detail below. A movement of a respective mounting clip of the set of mounting clips 114 from the original position and into a bent position will be described in further detail in relation to FIG. 2. The benefit of forming the set of mounting clips to include the elastic material (e.g., movable between the original position and bent position) is that each mounting clip of the set of mounting clips 114 is reusable and can be mounted and dismounted from the fascia 106 at will, which will be described in further detail below.

The lighting system 108 is selectively coupled to the set of mounting clips 114. As a non-limiting example, the set of light wires 112 of the lighting system 108 can be received within or otherwise coupled to the receiving body 116.

The set of mounting clips 114 is selectively couplable to the building 100. Specifically, the set of mounting clips 114 is selectively couplable to the fascia 106. When couped to the fascia 106, the first arm 118 extends along a respective portion of the lip 130 and hooks around the transition edge between the fascia surface 128 and the lip 130. The hook of the first arm 118 extends around the transition edge 132 to create contact between the fascia 106 and the first lock 120. The engagement between the first arm 118 and the fascia 106, via the first lock 120, limits a movement of the mounting clip along the fascia 106.

The set of mounting clips 114 includes any number of one or more mounting clips. A total number of mounting clips 114 used can be dependent on the size and weight of the lighting system 108. As a non-limiting example, if the lighting system 108 weighs 15 lbs, and each mounting clip of the set of mounting clips 114 is rated to carry 5 lbs, then a total of three mounting clips can be used to mount the lighting system 108 to the fascia 106. The set of mounting clips 114 can be evenly distributed along the lighting system 108. Alternatively, the set of mounting clips 114 can be non-evenly distributed along the lighting system 108.

While described in terms of the set of mounting clips 114 being used to mount the light system 104 to the building 100, it will be appreciated that the set of mounting clips 114 can be used to mount any suitable system or structure to the building 100. As a non-limiting example, the set of mounting clips 114 can be used to mount a set of wires (e.g., cables similar to the set of light wires 112), tubing, string, or a combination thereof to the building 100. The set of wires, the tubing, the string, the set of light wires 112, or the like will hereinafter be referred to as a set of conduit. It will be appreciated that the set of mounting clips 114 effectively mount the set of conduit to the building. The set of conduit can be, for example, a set of wires for security system of the building 100, a water pipe or tube used to convey water along the building 100, a string to mount decorations to the building 100, the set of light wires 112, or the like. It will be appreciated that the set of mounting clips 114 are adapted to receive the set of conduit. Specifically, the receiving body 116 is adapted to receive the set of conduit.

FIG. 2 is a cross-sectional side view of the building 100 as seen from sectional line II-II of FIG. 1. The receiving body 116 of each mounting clip of the set of mounting clips 114 includes various structures to accept or otherwise capture a respective portion of the lighting system 108. As a non-limiting example, the receiving body 116 includes an eye hole 126 or through-hole that the set of light wires 112 of the light system 108 positioned within.

Each mounting clip of the set of mounting clips 114 includes a second arm 122. The second arm 122 includes a second main body 148 and a second hooked end 150 that collectively form a second lock 124. The second arm 122 extends from a respective portion of the receiving body 116. It will be appreciated that the first arm 118 and the second arm 122 extend from opposing or otherwise opposite ends of the receiving body 116. The second arm 122, as illustrated, is formed as a V-shaped hook. It will be appreciated that the second arm 122 has any suitable formation such as, but not limited to, the V-shaped hook, a U-shaped hook, an L-shaped hook, the like.

To couple each mounting clip of the set of mounting clips 114 to the fascia 106, the first arm 118 is bent in a first bending direction 134. The mounting clip 114 is then slid over an open end 142 of the lip 130 in a first direction 138. The mounting clip 114 is oriented in such a way that the first arm 118 and the second arm 122 are provided on opposing sides of the lip 130. Once the first lock 120 passes the transition edge 132, the first lock 120 is urged in the second bending direction 136 and into the illustrated position. It will be appreciated that since the mounting clip 114 includes an elastic material, the first arm 118 is urged into the illustrated position after bending the first arm 118 in the first bending direction 134. It will be appreciated that the mounting clip 114 is not fully returned into its manufactured state (e.g., its zero-deformation state or otherwise unbiased state) and the mounting clip 114 will exert a compressive force along the lip 130. Specifically, the second arm 122 is urged towards the first arm 118, thus creating the compressive force along the lip 130. The second arm 122 is formed such that the compressive force is concentrated to a small area of the lip 130, thus forming the second lock 124.

The first lock 120 and the second lock 124 collectively hold the mounting clip 114 in the illustrated position along the fascia 106. The first lock 120 and the second lock 124 are further formed such that they limit movement of the mounting clip 114 with respect to the fascia 106 once the mounting clip 114 is secured to the lip 130.

The mounting clip 114 is selectively couplable to the fascia 106. To remove the mounting clip 114 from the fascia 106, the first arm 118 can be bent in the first bending direction 134 such that the first lock 120 becomes disengaged. Once past the transition edge 132, the mounting clip 114 can be moved in the second direction 140 and beyond the lip 130 to effectively remove the mounting clip 114 form the fascia 106.

The lighting system 108, as discussed herein, is secured to the mounting clip 114 via the receiving body 116. The mounting clip 114 is selectively couplable to the fascia 106. As such, the light system 108 is selectively coupled to the fascia 106 through use of the set of mounting clips 114.

As described herein, the elastic material of the set of mounting clips 114 allows the set of mounting clips to be mounted and dismounted to the fascia 106 such that the set of mounting clips 114 re reusable. Further, the set of mounting clips 114 attach to the fascia through use of the elastic material and the compressive force exerted on the fascia 106 through use of the set of mounting clips 114. The coupling of the set of mounting clips 114 to the fascia is done without the need for external couplings such as, but not limited to, adhesives, screws, nails, fasteners, or the like. It is contemplated that the external couplings can, in some instances, damage the fascia 106, or otherwise can be a burden to apply. As such, the use of the set of mounting clips 114 without the use of external couplings reduces the overall complexity of the lighting system 108, which reduces the burden of mounting the lighting system 108 to the fascia 106, but also eliminates the possibility of the set of mounting clips 114 and/or the lighting system 108 from damaging the fascia 106.

FIG. 3 is a schematic perspective view a mounting clip of the set of mounting clips 114 of FIG. 1. The mounting clip 114 includes the receiving body 116. The receiving body 116 can include the eye hole 126. The first arm 118 and the second arm 122 each extend from respective portions of the receiving body 116. It will be appreciated that the first arm 118 and the second arm 122 extend from opposing ends of the receiving body 116, or the eye hole 126 that are spaced from one another. As such, the eye hole 126 is formed with an open end 142. The first arm 118 and the second arm 122 extend from opposing ends of the receiving body 116 such that the open end 142 is formed therebetween. The open end 142 allows for the set of conduit (e.g., the set of light wires 112 of FIG. 1) to be slid into the eye hole 126 prior to the mounting clip 114 being mounted to the fascia 106 (FIG. 1).

The first arm 118 includes the first lock 120. The second arm 122 includes the second lock 124. The illustrated configuration of the mounting clip 114 is in its manufactured form (e.g., zero-deformation state or otherwise unbiased state). The illustrated configuration of the mounting clip 114 is what the mounting clip 114 is urged to when the first arm 118 bent in the first bending direction 134 (FIG. 2).

Benefits of the present disclosure include a mounting clip selectively coupled to the fascia in such a way that does not cause damage to the fascia when compared to conventional mounting methods. For example, the conventional mounting methods can require that the external couplings are used such as, but not limited to, aa screw, a nail, a staple, an adhesive, or the like is applied to the building in order to couple the light system to the building. If it is desired to remove the light system from the building, the conventional coupling method must be removed. The act of applying the conventional coupling method and/or removing the conventional coupling method from the building can cause damage to the building. The mounting clip, as described herein, is designed to secure the lighting system to the building without lasting damage to the building itself.

Further benefits include the location of where the mounting clips mount the light system to the building. For example, the conventional light systems can be mounted, via the conventional mounting methods, to the roof or exterior wall of the building. It is contemplated that debris (e.g., leaves), ice, snow, rain, or the like can form along the roof or the exterior wall and come into contact with the conventional light systems. In some cases, the buildup of debris, ice, or snow can cover the set of lights of the light system and mute or otherwise stop the light from the set of lights from being transmitted into the environment surrounding the house, thus defeating the purpose of mounting light system to the building.

In other cases, the buildup of debris, snow, ice, rain, or the like can cause damage to the light system or otherwise cause the light system to become decoupled from the building. For example, during winter it is common for ice or snow buildup to fall from a roof as the ice or snow melts or otherwise becomes dislodged from the roof. This falling of the snow and/or ice can come into contact with the light system and cause the light system to decouple from the building. This can, in some cases, cause damage to the building by, for example, dislodging shingles from the roof, tearing gutters off the roof, or the like. The mounting clip, as described herein, however, mounts the light system to an underside of the fascia (e.g., the lip). This mounting position of the light system shields the light system from the environment, thus greatly reducing the effect that the environment has on the light system and the mounting clip when compared to the conventional light system and the conventional mounting methods.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A mounting clip for mounting a set of conduit to a building, the mounting clip comprising a receiving body adapted to receive the set of conduit, and a first arm extending from the receiving body including a main body and a hooked end collectively forming a first lock for securing the mounting clip to the building.

The mounting clip of any preceding clause, further comprising a second arm extending from the receiving body.

The mounting clip of any preceding clause, wherein the first arm and the second arm extend from opposite ends of the receiving body.

The mounting clip of any preceding clause, wherein the second arm applies a compressive force towards the first arm to form a second lock when the mounting clip is secured to the building.

The mounting clip of any preceding clause, wherein the second arm forms a V-shaped hook.

The mounting clip of any preceding clause, wherein the first arm, the second arm, and the receiving body form a unitary body.

The mounting clip of any preceding clause, wherein the first arm, the second arm, and the receiving body include an elastic material.

The mounting clip of any preceding clause, wherein the first arm forms an L-shaped hook.

The mounting clip of any preceding clause, wherein the receiving body includes an eye hole.

The mounting clip of any preceding clause, wherein the eye hole has an open end.

The mounting clip of any preceding clause, further comprising a second arm extending from the receiving body.

The mounting clip of any preceding clause, wherein the first arm and the second arm extend from opposing ends of the receiving body such that the open end is located therebetween.

The mounting clip of any preceding clause, wherein the receiving body and the first arm form a unitary body.

The mounting clip of any preceding clause, wherein at least the first arm includes an elastic material.

The mounting clip of any preceding clause, further comprising a second arm extending from the receiving body, with the second arm including the elastic material.

The mounting clip of any preceding clause, wherein the set of conduit is a set of light wires for a light system.

The mounting clip of any preceding clause, wherein the building includes a fascia, with the mounting clip secured to the fascia.

The mounting clip of any preceding clause, wherein the fascia comprises a fascia surface and a lip extending from the fascia surface at a transition edge, and the first arm extends along a respective portion of the lip and hooks around the transition edge between the fascia surface and the lip.

The mounting clip of any preceding clause, wherein the mounting clip is selectively couplable to the building.

The mounting clip of any preceding clause, wherein the building a residential house.

What is claimed is:

1. A mounting clip for mounting a set of conduit to a building, the mounting clip comprising:
a receiving body adapted to receive the set of conduit; and
a first arm extending from the receiving body including a main body and a hooked end collectively forming a first lock for securing the mounting clip to the building.

2. The mounting clip of claim 1, further comprising a second arm extending from the receiving body.

3. The mounting clip of claim 2, wherein the first arm and the second arm extend from opposite ends of the receiving body.

4. The mounting clip of claim 2, wherein the second arm applies a compressive force towards the first arm to form a second lock when the mounting clip is secured to the building.

5. The mounting clip of claim 2, wherein the second arm forms a V-shaped hook.

6. The mounting clip of claim 2, wherein the first arm, the second arm, and the receiving body form a unitary body.

7. The mounting clip of claim 2, wherein the first arm, the second arm, and the receiving body include an elastic material.

8. The mounting clip of claim 1, wherein the first arm forms an L-shaped hook.

9. The mounting clip of claim 1, wherein the receiving body includes an eye hole.

10. The mounting clip of claim 9, wherein the eye hole has an open end.

11. The mounting clip of claim 10, further comprising a second arm extending from the receiving body.

12. The mounting clip of claim 11, wherein the first arm and the second arm extend from opposing ends of the receiving body such that the open end is located therebetween.

13. The mounting clip of claim 1, wherein the receiving body and the first arm form a unitary body.

14. The mounting clip of claim 1, wherein at least the first arm includes an elastic material.

15. The mounting clip of claim 14, further comprising a second arm extending from the receiving body, with the second arm including the elastic material.

16. The mounting clip of claim 1, wherein the set of conduit is a set of light wires for a light system.

17. The mounting clip of claim 1, wherein the building includes a fascia, with the mounting clip secured to the fascia.

18. The mounting clip of claim 17, wherein:
the fascia comprises a fascia surface and a lip extending from the fascia surface at a transition edge; and
the first arm extends along a respective portion of the lip and hooks around the transition edge between the fascia surface and the lip.

19. The mounting clip of claim 1, wherein the mounting clip is selectively couplable to the building.

20. The mounting clip of claim 1, wherein the building a residential house.
